(19) United States
(12) Patent Application Publication
(10) Pub. No.: US 2006/0170928 A1
(43) Pub. Date: Aug. 3, 2006

(54) Masila's cancer detector based on optical analysis of body fluids

(76) Inventors: Vadivel Masilamani, Chennai (IN); Masilamani Elangovan, Herndon, VA (US)

Correspondence Address: MASILAMANI ELANGOVAN, 13437 ELEVATION LANE, HERNDON, VA, 20171, US

(21) Appl. No.: 11/017,913

(22) Filed: Dec. 22, 2004

Related U.S. Application Data
(60) Provisional application No. 60/531,987, filed on Dec. 24, 2003.

(51) Int. Cl. G01J 3/45

(52) U.S. Cl. 356/451

(57) ABSTRACT

An apparatus for optical analysis of body fluids for cancer detection comprising: a light source for generating light rays,(incoherent lamp or laser) an excitation wavelength determination means, a grating for receiving optical rays from the body fluids, said optical rays being received at right angles to the optical rays incident on the said body fluids, an optical conversion means for receiving optical rays of from the said grating and converting the said optical rays to electrical signals, a computer for receiving and processing said the electrical signals. And the technique and process of the following preparing the blood and urine samples and their extracts. obtaining emission excitation and synchronous spectra. ratio fluorometry to identify the spectral signature of cancer specific molecules such as Porphyrin, Billurubin, Billiverdin, Riboflavin, Tryptophane, NAD(P)H etc. evaluating pre-malignant, early and advanced stages of cancer of any etiology.

### CROSS REFERENCE TO RELATED APPLICATIONS:

1) Cancer Diagnosis by auto fluorescence of blood components. Journal of Luminescence Vol. 109 pp 143-158 (2004) V. Masilamani, K. Al Zhami, M. Al-Salhi, A. Al-Diab, M. Al-Ageily.

2 Diagnosis of Cancer from blood by native fluorescence Asian Journal of Physics, Vol. 12 pp. 125-132 (2003). V. Masilamani, N. Sivakumar and K. Vijay Anand.

3) Spectrofluorimetric Detection of DMBA-Induced Mouse-Skin Carcinoma. Pathology Oncology Research Vol. 5 pp. 46-49 (1999). K. Karthikeyan, V. Masilamani, S. Govindasamy.

### FEDERALLY SPONSORED RESEARCH

NONE.

### FIELD OF THE INVENTION

The present invention relates to an apparatus and technique for the mass screening through optical analyses of body fluids. More particularly, the present invention relates to a mass screening apparatus for optically analyzing body fluids to diagnose the presence of carcinogenic cells found in any part of the human body.

### BACKGROUND OF THE INVENTION

Cancer has always been a dreaded disease. In spite of the advances in science and medical care, cancer is curable only when detected early. There are some techniques already in practice for detecting and staging of cancer. Some of them are surgical biopsy, protein sequence analysis (PSA) tests, DRE tests, computerised axial tomography (CAT or CT) scan, magnetic resonance imaging (MRI) scan, ultra-sound scan, bone scan, positron emission tomography (PET) scan, bone marrow test, barium swallow, endoscopy, cytoscopy test, T/Tn antigen test, mammogram etc. Each one of the above-mentioned tests has its own merits and demerits but none of them can be used effectively for mass screening at the primary diagnostic level.

For example techniques like PSA, Pap Smear, Mammogram are specific for cancer of a particular organ (prostrate, cervix, breast). Many of the diagnostic tests like endoscopies, bone marrow and cytoscopy test etc are invasive and distressful to the patients. Furthermore tests like MRI and CAT scan are generally expensive and involve complex instrumentation. There is no generic, non-invasive and simple diagnostic test. Masila's cancer detector is a generic, non-invasive and simple technique.

The diagnostic procedures for cancer are presently done in three levels. The primary level is when the patient meets the clinician, a report is taken from the patient and the doctor does a physical examination. If a tumor is suspected, at the primary level, the patient is referred to specific tests such as CAT scan, PSA etc under the secondary level. For further confirmation before launching the treatment methods, a set of tertiary level test such as biopsy involving histopathology and cytopathology are carried out.

The invention provides an apparatus for optical analysis of body fluids in the primary and secondary level of diagnostic testing of cancer. The tests are non-invasive and non-specific, hence cancer of any type, in any part of the body can be detected easily. Furthermore, the apparatus according to the present invention is relatively simple and can be used for mass screening.

### SUMMARY OF THE INVENTION

The present invention provides an apparatus for the optical analysis of body fluids. More particularly, the present invention relates to an apparatus for optically analyzing body fluids in order to diagnose the presence of carcinogenic cells present in any part of the human body. This is based on fluorescence of bio-molecules found in body fluids like blood, urine and their extracts. The analysis can be carried out based on fluorescence emission spectra, fluorescence excitation spectra and synchronous spectra of the body fluids. The apparatus consists of an optical source such as a lamp or laser at a predetermined wavelength and spectral width. The rays from the optical source are directed to an excitation wavelength determining means (say a grating or a filter) and are focused on a sample of body fluids. The body fluid sample is kept in a transparent cuvette. The fluorescence optical rays from the cuvette, which are at right angles to the light incident on the body fluid sample in the cuvette, are focused with the help of a focusing means (lens) to a grating. From here the optical rays are passed through a slit. The wavelength of the optical rays required is isolated with the help of the slit and the grating. The fluorescence optical rays of a required predetermined wavelength are given as input to an optical conversion means which converts the optical rays into analog electrical signals. The analog signals are then digitized and given as input to a computer for processing the results of the analysis carried out by the apparatus according to the present invention. When we scan the grating and collect signal at different wavelength, we get fluorescence bands, which represent intensity of fluorescence, in relative units, as a function of wavelength. These bands are the finger prints of health or disease.

The apparatus for optical analysis of body fluids comprises of:
(a) optical source for generating light or laser rays
(b) excitation wavelength determining means for receiving the optical rays from said optical source and transmitting the optical rays at a required wavelength
(c) a cuvette for holding body fluids and for receiving the optical rays from the excitation wavelength determining means
(d) a grating for receiving the optical rays from the cuvette which is at right angles to the optical rays incident on the cuvette and transmitting the optical rays
(e) a slit provided between the said grating and an optical conversion means for directing the optical rays received at a particular wavelength from the grating to the optical conversion means
(f) said optical conversion means being provided for converting the optical rays received from the said grating to electrical signals
(g) a computer for receiving and processing the said electrical signals.

The optical source may be a coherent light source (laser) or an incoherent light source (halogen lamp). The excitation wavelength determining means may be an interference filter, a notch filter or a grating. The optical conversion means may be a photo detector (photo diode, photo multiplier or CCD array).

### BRIEF DESCRIPTION OF THE DRAWINGS AND FIGURES

FIG. 1: Shows a schematic diagram of an apparatus for optical analysis of body fluids according to the invention

FIG. 2: Shows a schematic diagram of a simplified version of the above apparatus for optical analysis of body fluids according to the invention.

FIG. 3: Shows a schematic diagram of another simplified version of above apparatus for optical analysis of body fluids according to the invention.

FIG. 4: Shows a schematic diagram of a preferred and advanced embodiment of an apparatus for optical analysis of body fluids according to the invention.

FIG. 5: Shows the fluorescence emission spectra for tests performed on extracts of formed elements of blood of a healthy patient.

FIG. 6: Shows the fluorescence emission spectra for tests performed on extracts of formed elements for a cancer diseased patient.

FIGS. 7a, 7b and 7c: Shows the fluorescence emission spectra of formed elements of blood of experimental animal models (albino mice). Figures a, b and c show the different stages healthy, early and advanced stage of cancer.

FIG. 8: Shows the histogram of ratio fluorescence (R1) to discriminate healthy and diseased conditions.

FIG. 9: Shows the fluorescence emission spectra of urine analysis done for a healthy patient. (Excitation at 325 mn)

FIG. 10: Shows the fluorescence emission spectra of urine analysis done for a diseased patient. (Excitation at 325 nm)

FIG. 11: Shows the fluorescence emission spectra of healthy patient based on urine analysis at 400 nm excitation wavelength.

FIG. 12: Shows the fluorescence emission spectra of diseased patient based on urine analysis at 400 nm excitation wavelength.

FIG. 13: Shows the fluorescence emission spectra based on tests performed on urine extracts in a healthy patient.

FIG. 14: Show the fluorescence emission spectra based on tests performed on urine extracts in a diseased patient.

FIG. 15: Show the fluorescence excitation spectra based on tests performed on extracts of formed elements of the healthy patient.

FIG. 16: Show the fluorescence excitation spectra based on tests performed on extracts of formed elements of the diseased patient.

FIG. 17: Shows the fluorescence synchronous spectra based on blood plasma analysis of a healthy patient.

FIGS. 18: Shows the fluorescence synchronous spectra based on blood plasma analysis of a diseased patient.

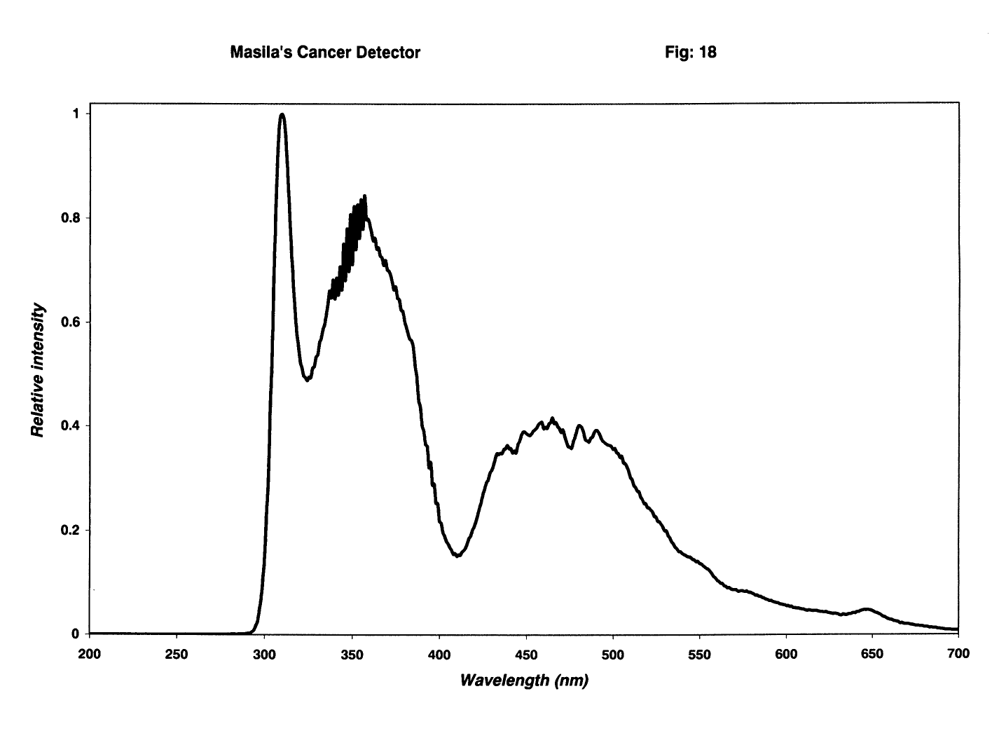

FIG. 19: Show the fluorescence synchronous spectra based on blood plasma analysis of a healthy patient at a different offset wavelength (Offset of 70 nm).

FIG. 20: Show the fluorescence synchronous spectra based on blood plasma analysis of a diseased patient at a different offset wavelength (Offset of 70 nm).

FIG. 21: Shows the fluorescence synchronous spectra based on blood plasma analysis for the healthy another offset wavelength (offset 30 nm).

FIG. 22: Shows the fluorescence synchronous spectra based on blood plasma analysis for the diseased another offset wavelength (offset 30 nm).

FIG. 23: Show the fluorescence synchronous spectra based on urine analysis for the healthy patient. (offset 70 nm).

FIG. 24: Show the fluorescence synchronous spectra based on urine analysis for the diseased patient. (offset 70 nm).

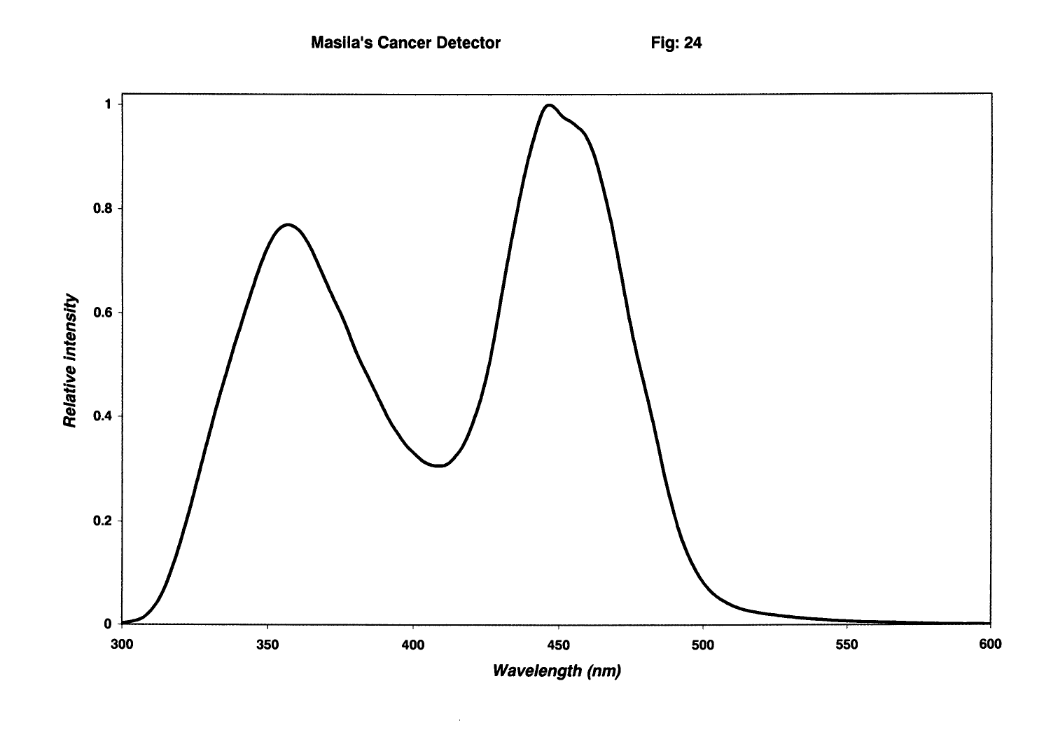

FIG. 25: Shows the fluorescence synchronous spectra based on urine analysis for the healthy patient at a different offset wavelength (offset is 30 nm).

FIG. 26: Shows the fluorescence synchronous spectra based on urine analysis for the diseased patient at a different offset wavelength (offset is 30 nm).

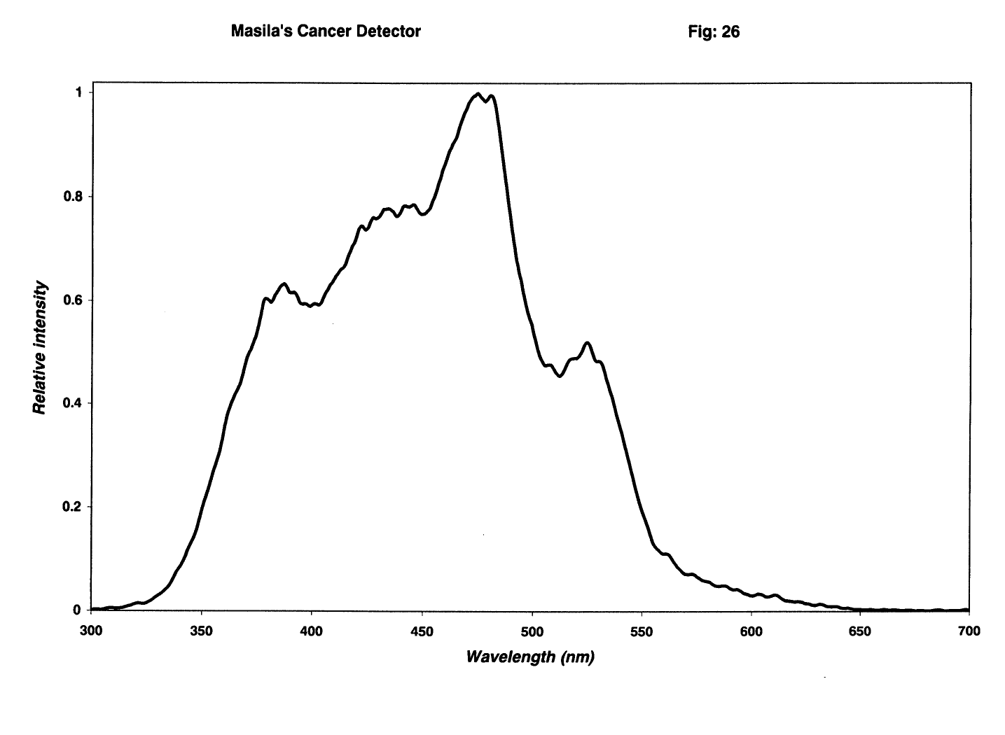

FIG. 27: Shows the fluorescence emission spectra based on urine analysis for the healthy patient employing a pulsed Ti-Saphire laser (at 400 nm) for a laser induced fluorescence excitation.

FIG. 28: Shows the fluorescence emission spectra based on urine analysis for the diseased patient employing a pulsed Ti-Saphire laser (at 400 nm) for a laser induced fluorescence excitation.

### DETAILED DESCRIPTION OF THE INVENTION

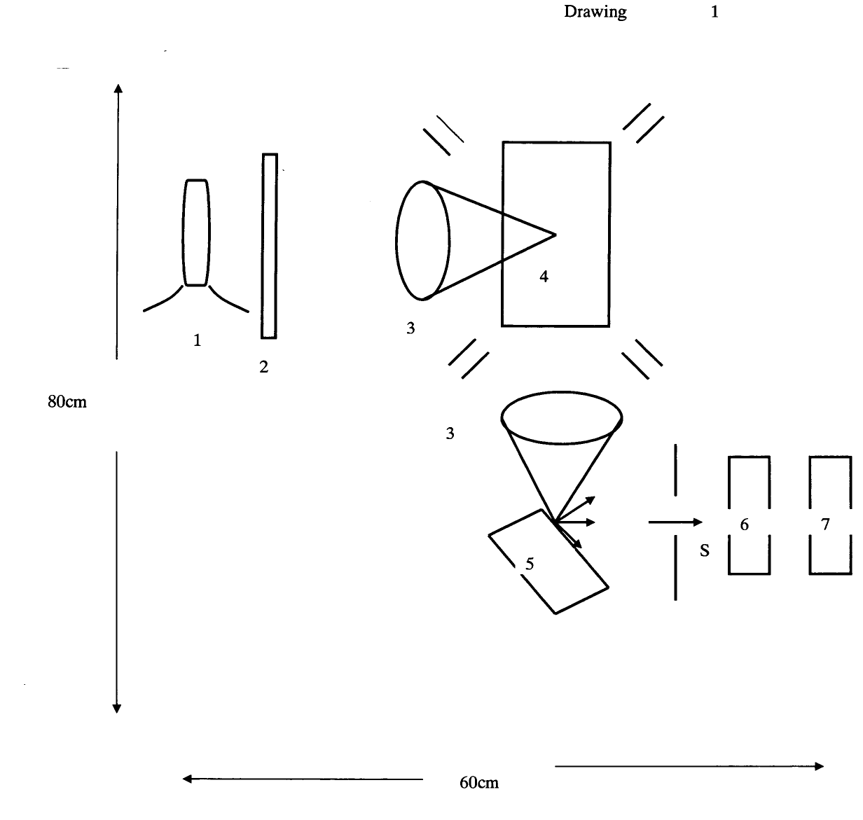

The apparatus shown in FIG. 1 consists of an optical source (1). The optical source can be an incoherent light source like halogen lamp, mercury lamp, xenon lamp or tungsten lamp. It can also be a coherent light source like a diode laser, helium- cadmium laser, frequency doubled Titanium (Ti) Sapphire laser, or a tunable dye laser at different levels of sophistication. The optical rays from the source (1) is directed to an excitation wavelength determining means (2). In this embodiment of the invention the excitation wavelength-determining means (2) may be an interference filter or a notch filter. The optical rays from the excitation wavelength determining means (2) correspond to a predetermined wavelength. These rays are focused on the sample of body fluids collected from a patient, through a first focusing means (3). The body fluids are placed in a transparent quartz cuvette (4).

The body fluids that are collected may be various substances based on the type of diagnosis required. The cuvette (4) may provide about 10 mm path length. Once the optical rays from the excitation wavelength determining means (2) fall on the body fluid sample kept in the cuvette (4), fluorescence optical rays are given off from the body fluid sample kept in the cuvette (2) at different angles. The fluorescence rays that are received from the cuvette (4) at an angle of 90° (right angles) from the rays incident on the cuvette (4) alone are used for analysis. Once the fluorescence optical rays that are at an angle of 90° are received, it is focused by second focusing means (3) to a grating (5). The grating (5) may be a ruled or a holographic grating of 1200 or 2400 lines per mm. The optical rays are then dispersed out from the grating (5). The fluorescence is often a band of wavelength of width 50 to 100 nm depending upon the sample. The combination of grating and the rectangular slit (2 mm×1 mm) selects fluorescence signal of 5 nm band width. When the grating is rotated, at a typical speed of 500 nm per minute, the entire fluorescence emission signal from the sample is scanned. The fluorescence band thus obtained is the signature of healthy or abnormal sample. The optical rays from the slit (5) is given to an optical conversion means (6) such as a photo multiplier tube or a photodiode placed after the rectangular slit. The optical conversion means (6) converts the received optical rays of a specific wavelength to electrical signals. These signals are in the form of analog signals. The analog signals are then fed to a computer (7). The computer (7) processes information collected based on the analysis performed by the apparatus and supplies the result of the optical analysis. Information processing in the computer is done with the help of a specially designed statistical analysis software customized to categorize and extract the results of the analysis performed.

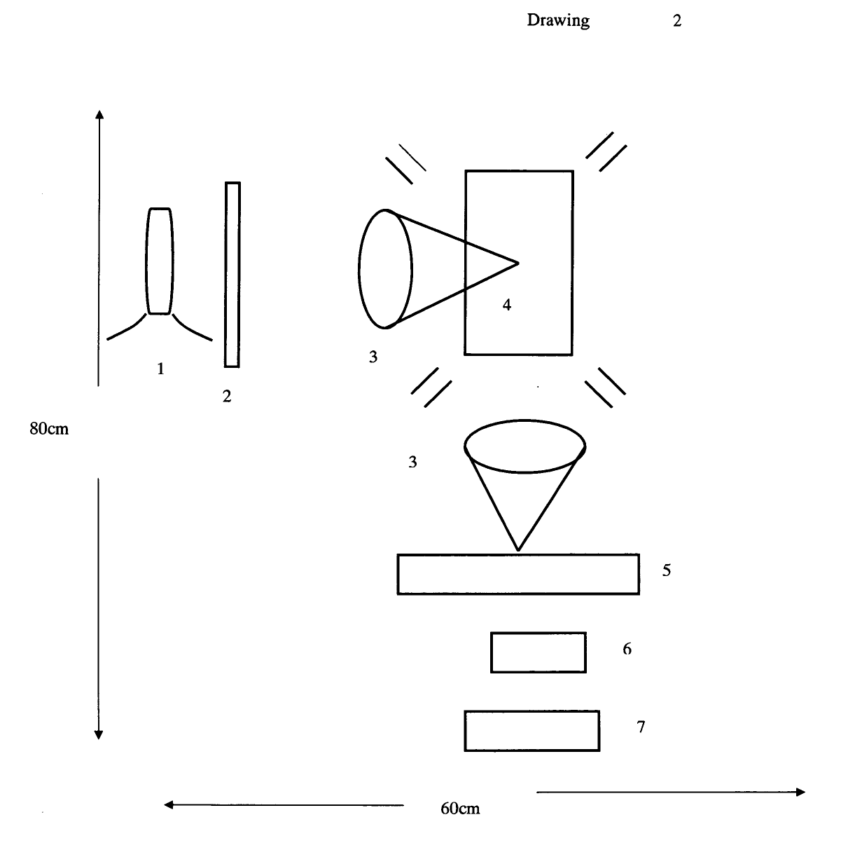

Referring to the simplified, less expensive version of the said Invention of apparatus given in FIG. 2 we use interference filters at three different wavelengths: 585 nm, 630 nm and 685 nm, these filters replace the grating given in apparatus of FIG. 1. Otherwise there is no other major difference between FIG. 1 and FIG. 2

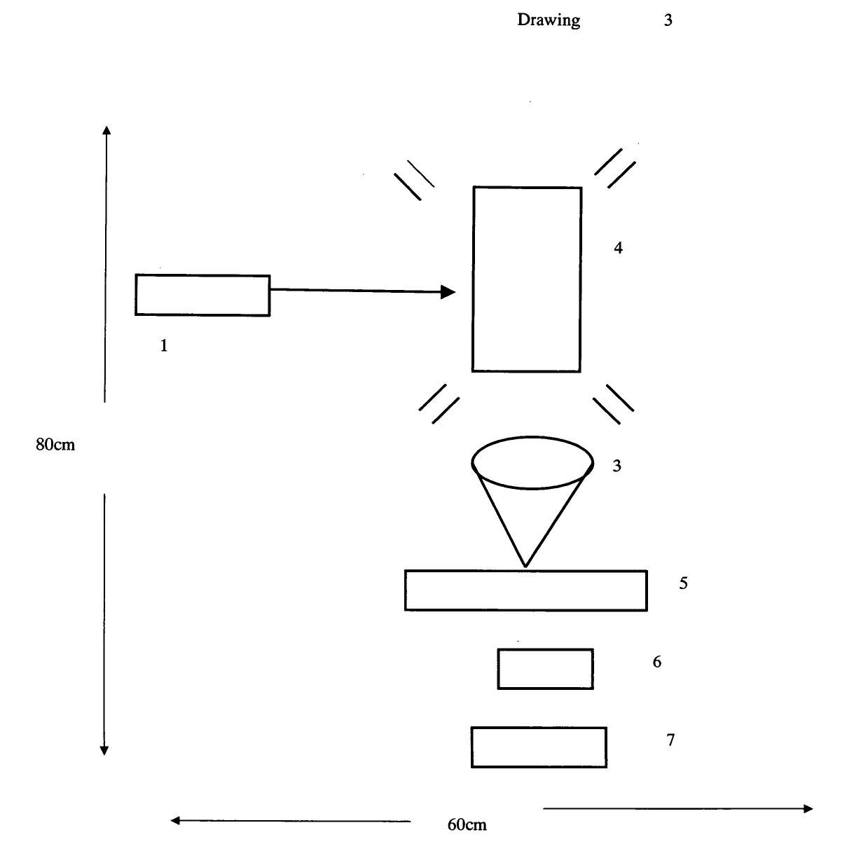

Referring to the FIG. 3 which is another but a slightly more expensive version we use a continuous wave (CW) blue diode laser of 405 nm and of power 5 mw as the optical source, This replaces the lamp and filter and lens (part 1, 2 and 3) of FIG. 2 Also we use an avalanche photodiode plus a an amplifier for the detection of fluorescent light signal this replaces the photo-multiplier of FIG. 2. Otherwise functions are the same as in FIG. 1

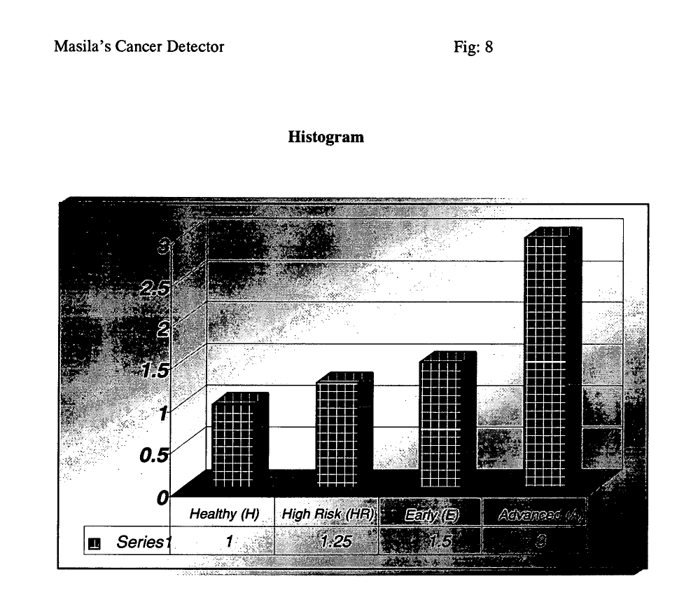

Using the above said set of filters which allow fluorescence signal at 585, 630 and 685 nm only respectively we can measure intensities only at these specified wavelengths and histogram as shown in FIG. 8 is obtained.

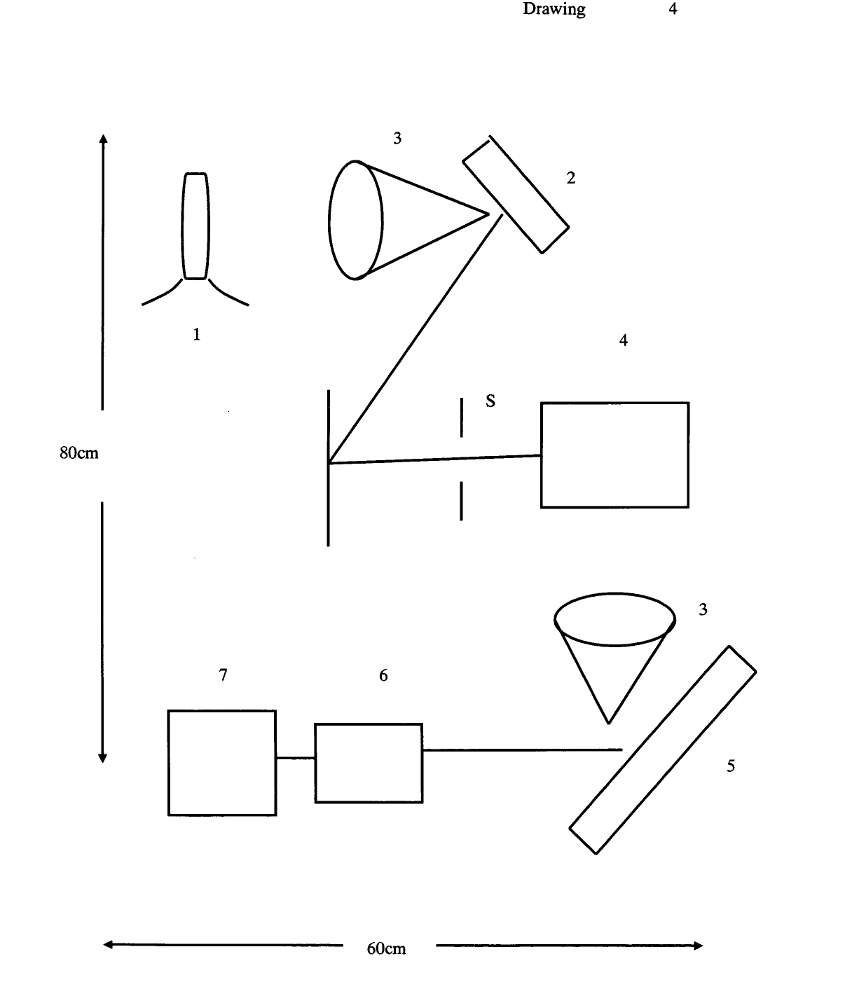

Referring to the preferred and more sophisticated embodiment shown in FIG. 4, the optical rays from the optical source (1) are allowed to fall on a grating (2) instead of the interference filter or the notch filter which comprises the excitation wavelength determining means (2) of FIG. 1. Thus, in the preferred embodiment of the invention, two gratings are present instead of one. The grating provided after of the optical source (1) is the excitation grating (2) and the grating after the body fluid sample kept in the cuvette (4) is the emission grating (5). The light rays from the optical source (1) are incident on the excitation grating (2). The wavelength of the rays to be focused on the cuvette (4) are isolated with this grating (2) and the slit (S) Once the predetermined excitation wavelength is chosen, the optical rays corresponding to that particular wavelength are directed to the body fluid sample kept in the cuvette (4) The remaining features of this embodiment are the same as already described in FIG. 1.

The results obtained from analysis done by the above mentioned apparatus give distinct signature and features of the bio-molecules specific to cancer. In order that the apparatus, according to the present invention, to function in the manner as required by the user for the analysis of different body fluids, various procedures should be followed before placing the body fluid sample in the transparent cuvette. Based on the types of samples tested and the wavelengths selected, various types of tests can be carried out. Typical tests are described below.

Tests Based on Fluorescence Emission Spectra of Body Fluids

Test 1

Extract of Formed Elements

Step 1: A disposable syringe is used to take 5 ml venous blood from the subject and put it in a sterile vial containing ethylene diamide tetra acetic acid (EDTA) anticoagulant.

Step 2: The blood is centrifuged at 4000 rpm for 15 min and the supernatant plasma is separated out and collected in a sterile vial.

Step 3: The formed element containing mostly cells such as erythrocyte is treated with acetone in the ratio of 1:2 (i.e., to the 1 ml of formed elements 2 ml of acetone is added). The sample is vigorously shaken 100 times and then centrifuged at 4000 rpm for 15 min.

The supernatant thus obtained is a clear solution containing the bio-molecules that are tumor markers. It is subjected to the optical analysis as described before.

Step 4: The wavelength of excitation is fixed at 405 nm by adjusting the interference filter and obtain fluorescence spectrum in the range of 425 to 720 nm.

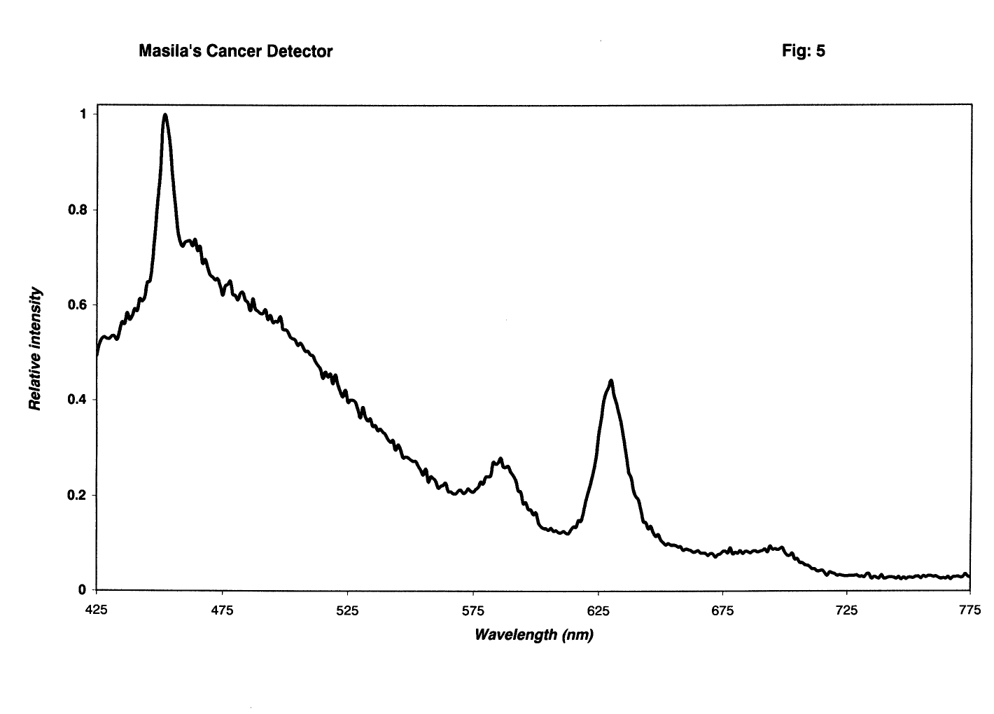

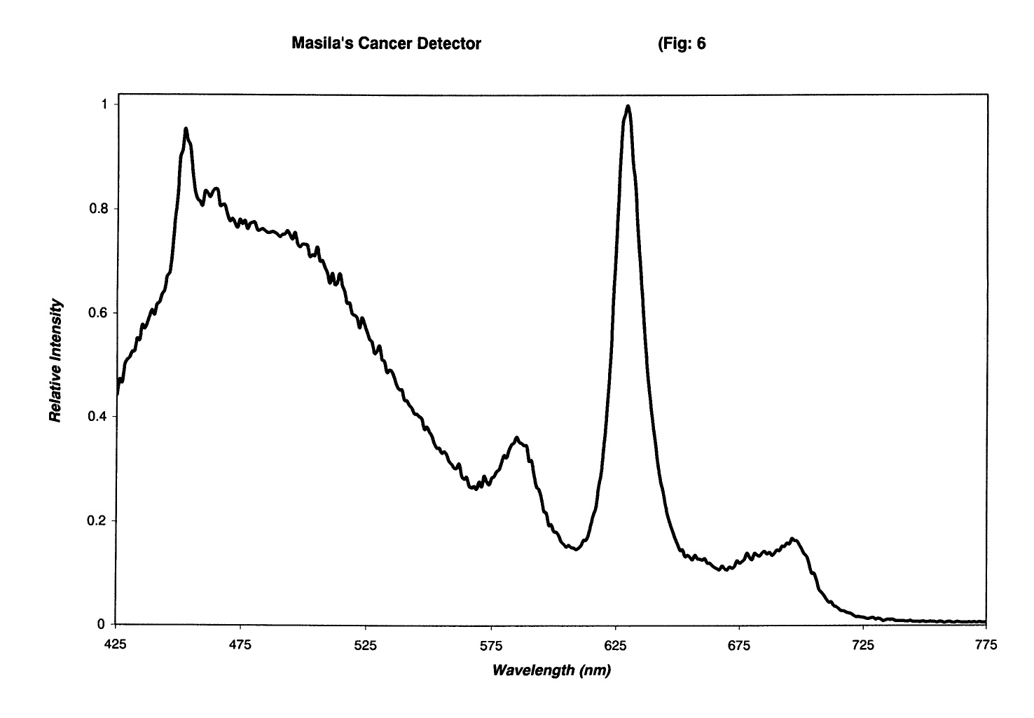

With reference to a typical result shown in FIG. 5 for healthy sample and FIG. 6 for cancer diseased sample, the spectrum consists of 4 bands
1) Around 460 nm, due to Raman scattering of acetone.
2) Fluorescence band at around 505 nm most probably due to riboflavin or a bile component.
3) Fluorescence band at around 585 nm due to anionic species of porphyrin.
4) Fluorescence band at around 630 nm due to neutral species of porphyrin.
5) Fluorescence band at around 695 nm due to cationic species of porphyrin.

Step 5: The intensities of the bands are measured and denoted as I₄₆₀, I₅₀₅, I₅₈₅, I₆₃₀, I₆₉₅

The ratios of intensities are denoted as.

Ratio (R₁)=(I₁₆₃₀/I₅₈₅)

If

R₁<1.5 it implies that the patient is healthy.

1.5<R₁<2.25 it implies that the patent is at high risk of cancer.

2.25<R₁<3 it implies that the patient is at the early stages of cancer

R₁>3 it implies that the patient is at the advanced stages.

We denote (R₂)=I₆₉₅/I₅₈₅

(R₃)=I₆₃₀/I₅₀₅

(R₄)=I₅₈₅/I₄₆₀

(R₅)=I₅₀₅/I₄₆₀

These fluorescence intensity ratio parameters are proportional to the ratio of concentration of above cited bio-molecules. These are in different ratio for healthy and diseased samples. They are summarized in Table 1.

TABLE I
FLUOROSCENCE INTENSITY RATIO FOR FORMED ELEMENTS

| FL. Int. Ratio | H | HR | E | A | C |
|---|---|---|---|---|---|
| R1 = 630/585 | <1.5 | >1.5 <2.25 | >2.25 <3.0 | >3.0 | 2 |
| R2 = 695/585 | 0.4 ± 0.1 | 0.5 ± 0.1 | 0.8 ± 0.2 | 1.5 ± 0.5 | 4 |
| R3 = 630/505 | 0.6 ± 0.2 | 1 ± 0.25 | 1.25 ± 0.25 | 2 ± 0.5 | 3 |
| R4 = 585/460 | 0.3 ± 0.1 | 0.5 ± 0.1 | 0.7 ± 0.1 | 1 ± 0.2 | 3.3 |
| R5 = 505/460 | 0.5 ± 0.1 | 0.7 ± 0.1 | 0.9 ± 0.1 | 1.2 ± 0.2 | 2.2 |

H—Healthy
HR—High Risk
E—Early stages of cancer
A—Advanced cases
C—Contrast Parameter

R₁, R₂ and R₃ are common for all types of cancer since it depends upon the concentration of porphyrin, a bio-molecule involved in heme metabolism. This is found at higher concentration in cancer patients than in healthy subjects because of the abnormal cell proliferation in the patients. This is in general the basis for laser based photodynamic therapy, which is in practice all over the world.

In the present invention, we are concerned with the concentration of porphyrin carried in the blood stream and excreted through urine. If the concentration of this fluorophore is higher then the tumor activity or the tumor volume is also higher. (See the histogram FIG. 8)

There are some special cases to this also.

Let us say R₄=(I₅₈₅/I₄₆₀)

If R₄<0.5 healthy

0.5<R₄<1.5 it implies early stage of Hodgkin's lymphoma.

Assuming Ratio (R₅)=(I₅₀₅/I₄₆₀)

If, R₅<0.5 it implies that the patient is healthy

0.5<R₅<0.75 it implies mild liver malfunction

0.75<R₅<1.0 it implies severe liver malfunction

This factor is distinct in pancreatic cancer with obstruction into the liver.

A few types of cancer detection tests were carried out based on the present invention. They are as follows.

1. Animal Models

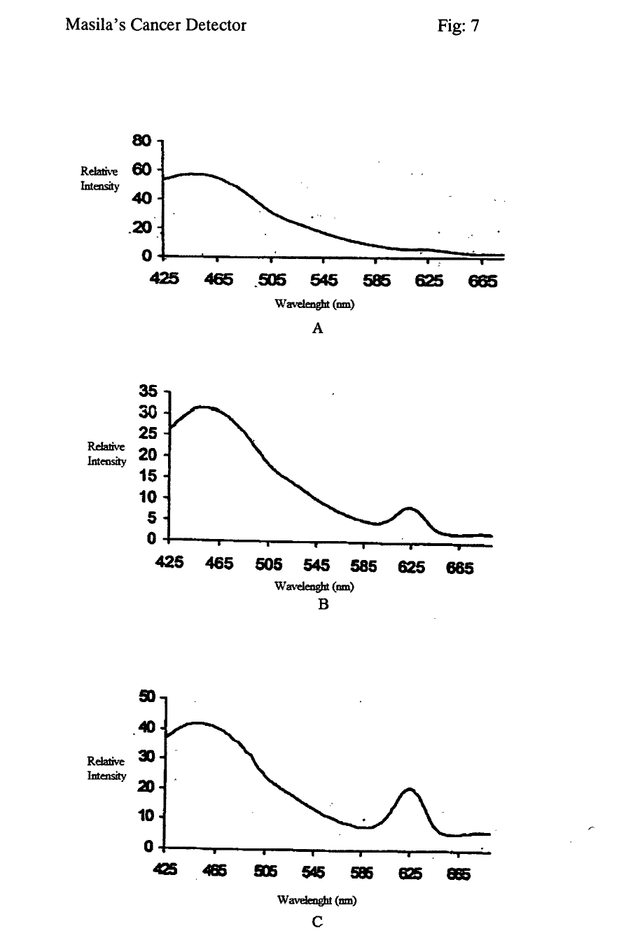

150 albino mice were studied in which squamous cell carcinoma had been induced using chemical carcinogen DMBA. These mice were sacrificed at different stages of cancer and blood samples taken were subjected to the sample analysis outlined above. The healthy blood and the (cancer) diseased blood showed distinct features It was seen that R₁=I₆₃₀/I₅₈₅ increases as the disease becomes more and more advanced. These results are shown in FIG. 7

2 ml of urine is dropped in a quartz cuvette. The excitation wavelength is set at 325 nm and the fluorescence spectrum is obtained from 350 to 600 nm. There is a smooth fluorescence band with a peak around 420 to 450 nm with a high intensity for healthy urine. There is a weak shoulder around 550 nm. The intensity ratio may be given as follows:
(R₆)=(I₅₅₀/I₄₃₀)<0.2

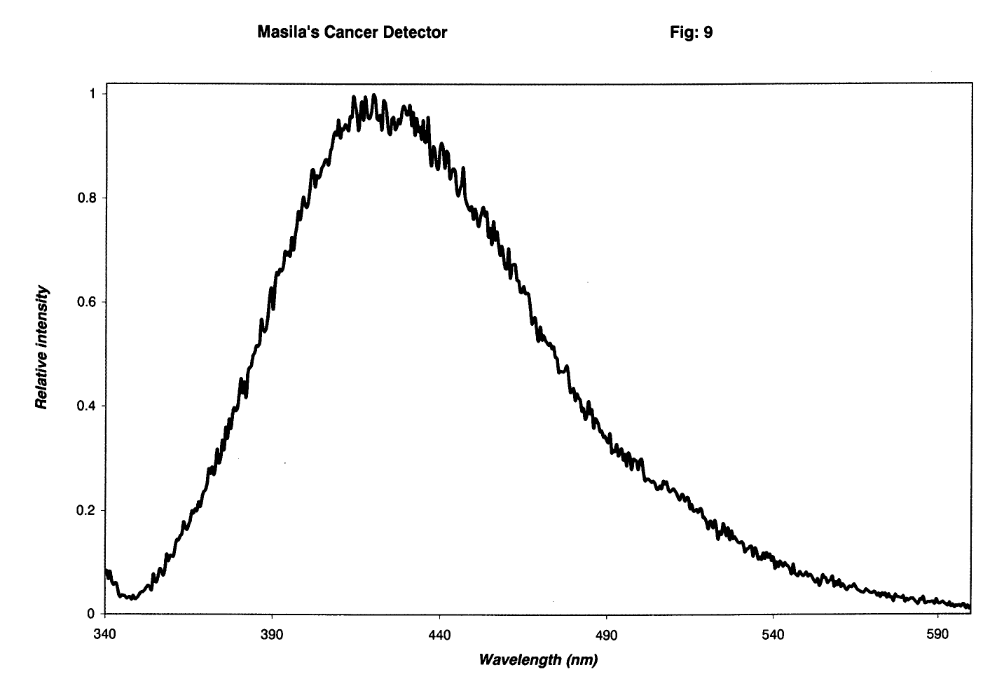

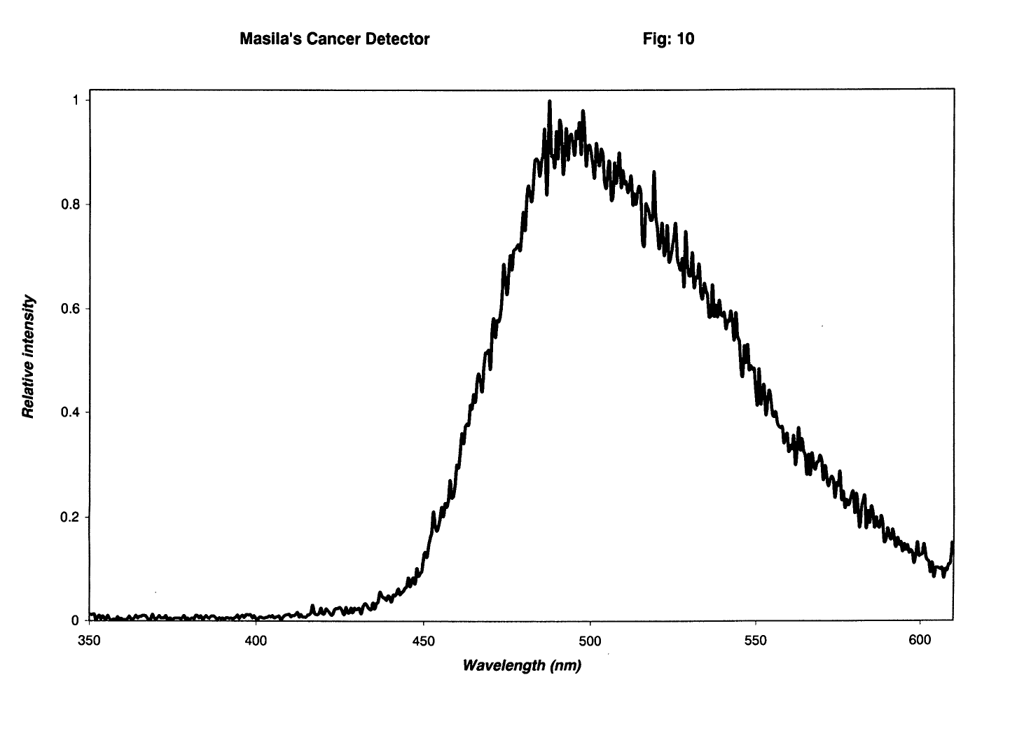

For cancer diseased patient there are two bands one around 500 nm and another around 550 nm with an intensity ratio (R₆)=(I₅₅₀/I₅₅₀) varying from 0.4 to 1. (See FIG. 9 for healthy, FIG. 10 for diseased)

But these two bands are at least 10 times weaker than the fluorescence of healthy urine.

The fluorescence band around 550 nm is most probably due to bilirubin. This is at least two times higher in concentration in cancer patients as compared to the healthy subjects.

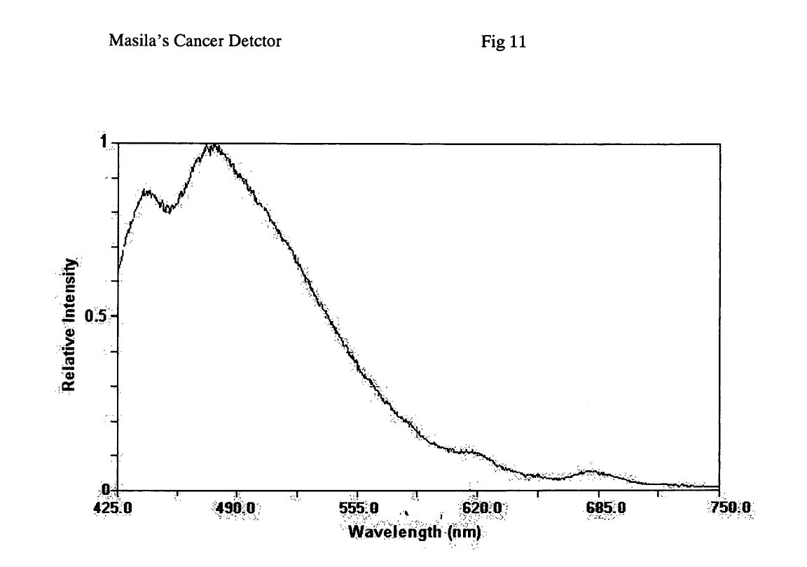

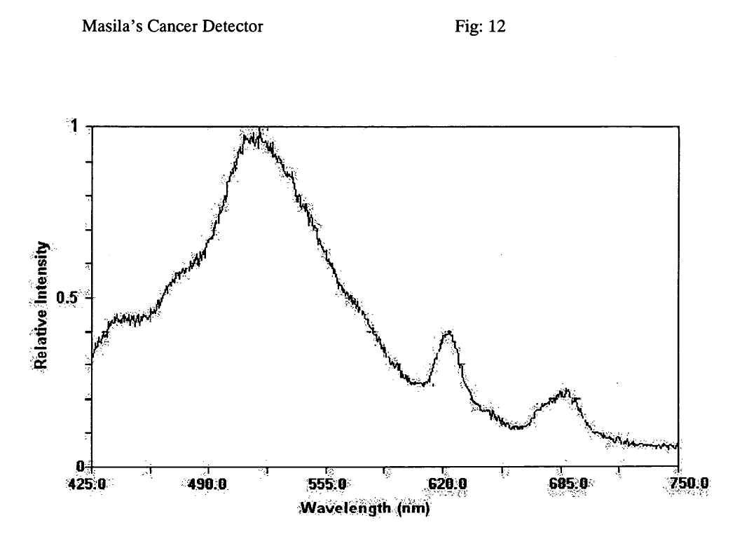

Next, the excitation wavelength is set at 405 nm and obtain fluorescence spectrum from 425 to 700 nm. (See FIG. 11 for healthy and FIG. 12 for diseased) There are many bands: 450 nm 470 nm, 500 nm, 550 nm, 580 nm and 620 nm and 685 nm. We ignore all except 470, 550, 620 nm bands, which are consistent. The notation may be given as follows:
(R₇)=(I₆₂₀/I₄₇₀) and (R₈)=(I₅₅₀/I₄₇₀)
for different stages of cancer development. Note that 585 mn band is not as distinct as in humans.
2. Field of Study in Human Patients

424 human patients were tested as a field study. The details of disease and diagnosis score are given below. The score was done with reference to the conventional histopathology.

TEST II

| | | | Correct | | |
|---|---|---|---|---|---|
| | | #. of | optical | Incorrect Diagnosis | |
| Item | Type of Subjects | Subjects | Diagnosis | False +ve | False −ve |
| 1 | Healthy | 130 | 123 | 7 | |
| | volunteers | | | | |
| 2 | Cancer of | 42 | 38 | | 4 |
| | Esophagus | | | | |
| 3 | Cancer of Thyroid | 38 | 38 | | 8 |
| 4 | Cancer of Breast | 64 | 64 | | 4 |
| 5 | Hodgkin's | 52 | 45 | | 7 |
| | Lymphoma | | | | |
| 6 | Cancer of | 28 | 26 | | 2 |
| | Stomach | | | | |
| 7 | Cancer of Colon | 31 | 27 | | 4 |
| 8 | Cancer of | 10 | 8 | | 2 |
| | Pancreas | | | | |
| 9 | Miscellaneous | 29 | 25 | | 4 |
| | Total Patients | 424 | 382 | 7 | 35 |

Urine Analysis

Test II A (Fresh Urine Sample)

| | |
|---|---|
| If R₇ < 0.5 and R₈ < 0.7 | it implies the subject is healthy |
| If R₇ > 0.5 and R₈ > 0.7 | it implies cancer |

Test II B
Extract of Urine

A reagent of ethyl acetate and acetic acid is prepared in the ratio of 4:1 (40 ml ethyl acetate to 10 ml of acid). In a test tube 2 ml of reagent and 1 ml of urine are added. After shaking well, it is allowed to settle for 10 minutes. Take the upper layer (about 1 ml) that has extracted cancer specific molecules. It is then subjected to optical analysis.

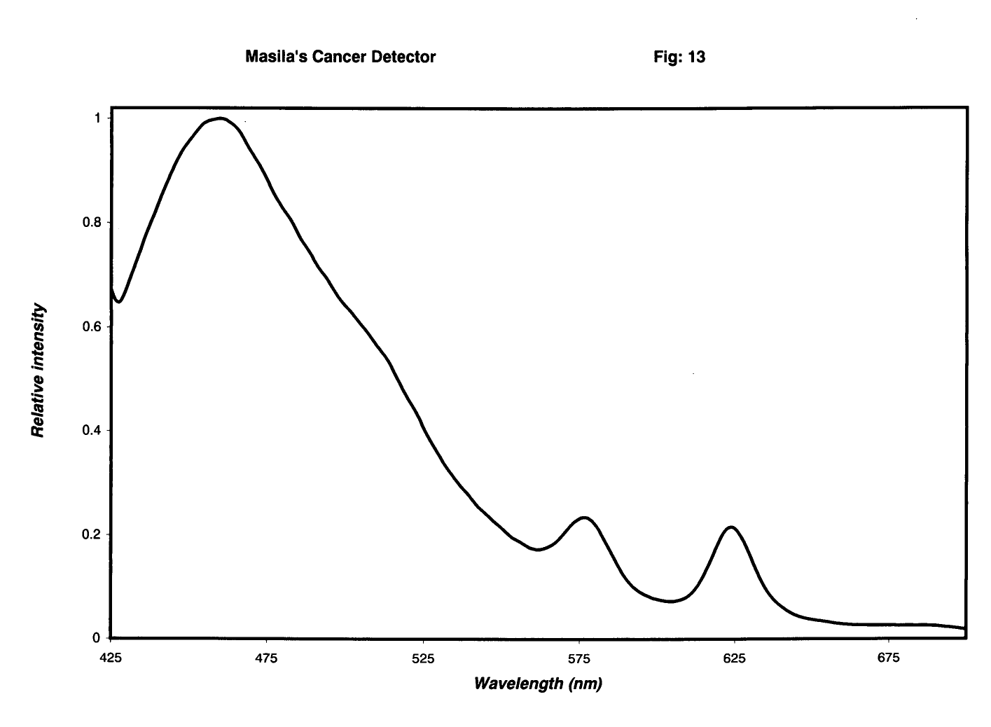

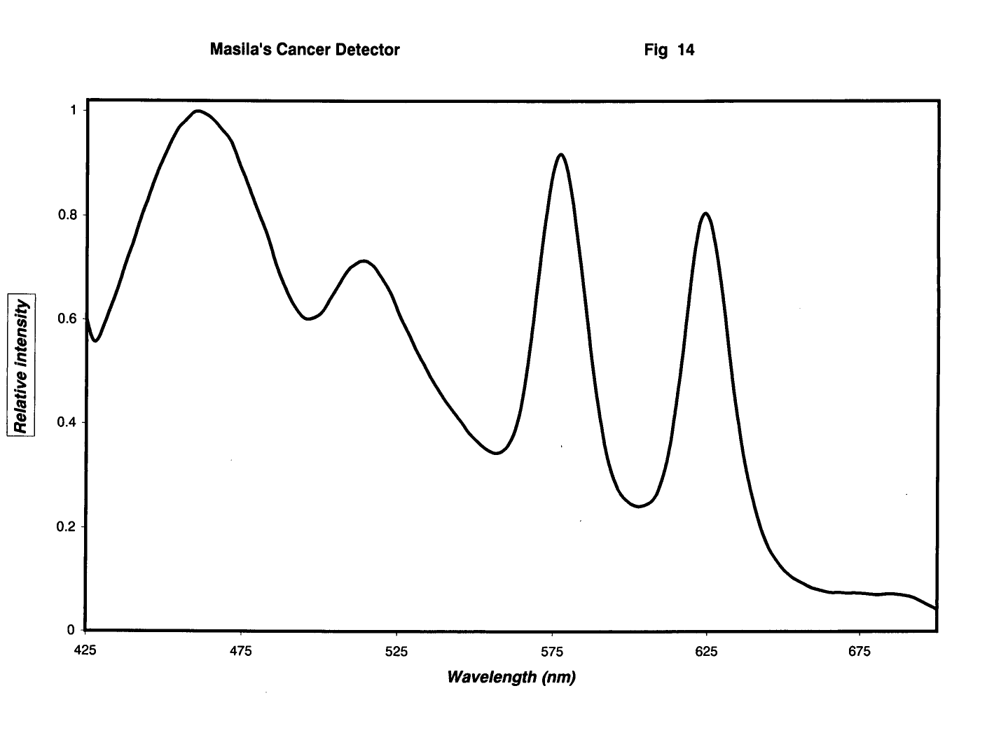

The wavelength is set at 405 and spectra from 425 to 720 nm are obtained. Four bands are obtained as follows: (See FIG. 13 for healthy and FIG. 14 for diseased)

1) 460 nm due to Raman Scattering of reagents

2) 525 nm due to bile component

3) 575 nm and 620 nm due to porphyrins.

The intensity of all bands is measured. The notation may be given as follows:
(R₉)=(I₆₂₀/I₅₂₅)

If R₉<0.75 it implies that patient is healthy.

0.75<R₉<1.5 it implies that cancer is early.

R₉>1.5 it implies that is advanced.

Thus nine parameters are obtained for mass screening of cancer from body fluids. The porphyrins, and also the bile components, found in higher concentration in the body fluids of cancer patients than the healthy subjects, are the tumor markers. These biomolecules, porphyrin and billirubin are involved in heme metabolism, which appear to be considerably altered by substances released by cancer. These biomolecules are the cancer specific fingerprints in laser or light induced fluorescence.

With the two above mentioned body fluids and the above mentioned parameters cancer mass screening can be done with a reliability factor of 80%.

Test III

Tests Based on Fluorescene Excitation Spectra and Synchronous Spectra of Body Fluids

Analysis based of the excitation and synchronous spectra can also be carried out to improve the specificity and reliability. Typical tests are described below.

Test III A

Excitation Spectrum

This is the inverse of fluorescence spectrum of the sample and under optimized conditions gives the absorption spectrum.

Procedure

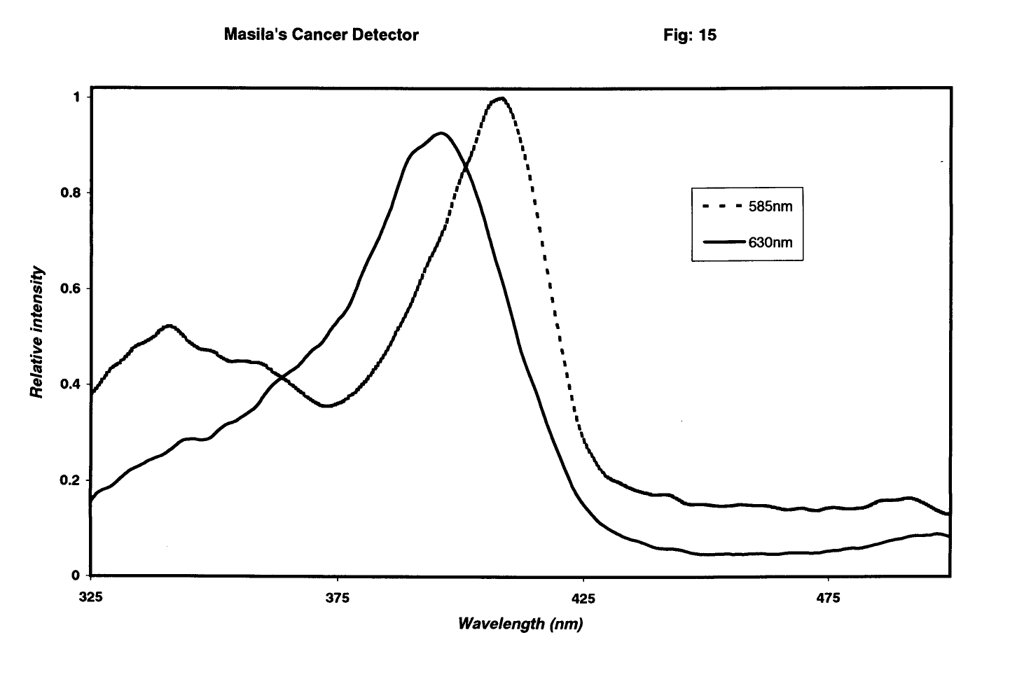

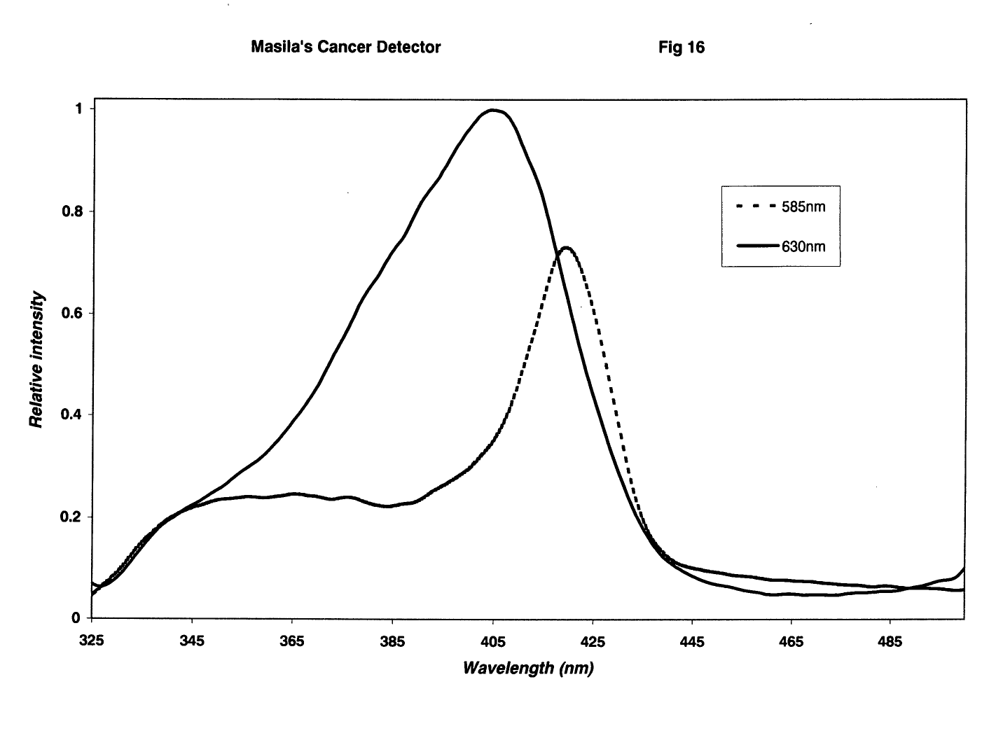

The sample (extract of formed elements, urine etc) is prepared and taken in the quartz cuvette. The emission grating (2) is fixed at 630 nm and the excitation grating (5) in FIG. 4 is scanned from 350 to 600 nm and the spectrum is recorded. The excitation spectrum has a primary peak around 398 nm, with a few secondary peaks. The intensity of I_{398 is} measured. Then the emission grating is fixed at 585 nm and scanned using grating G1 from 300 to 550 nm. This gives another excitation band, very similar to the previous one, but with a peak at 410 nm. These two are the excitation spectra of two species of porphyrin. (See FIGS. 15 and 16) The peak intensity of these two bands is measured. The ratios of these intensities are denoted as

ie (R₁₀) = (I₃₉₈/I₄₁₀)

| | | |
|---|---|---|
| If | R₁₀ < 0.8 | Healthy |
| | 0.8 < R₁₀ < 1.5 | Early cases of cancer |
| | R₁₀ > 1.5 | Advanced stages of cancer |

Test III B
Snychronous Spectra

With suitable modifications in the system as mentioned before, one more type of spectra is obtained i.e. Synchronous spectra for the same sample. This becomes an additional window of analysis. This is a compounded spectrum of fluorescence emission of many molecules but each molecule being excited at the absorption peak. It gives a better resolution and identification of weakly fluorescing, submerged fluorophore.

Procedure

Synchronous Spectra of Blood Plasma

The plasma sample is prepared and placed in the cuvette as before. The excitation Grating is set at 200 nm and emission Grating is set at 210 nm with an offset wavelength difference of 10 nm. Then synchronously both gratings are scanned. The fluorescence obtained with the excitation of 200 nm is collected from 210 nm onwards. Then the excitation grating moves to 210 and synchronously the emission grating moves to 210 and collects fluorescence; this kind of synchronous scanning goes on up to 700 nm

Such synchronous spectra obtained for any sample show distinct and marked differences between healthy and diseased fluid.

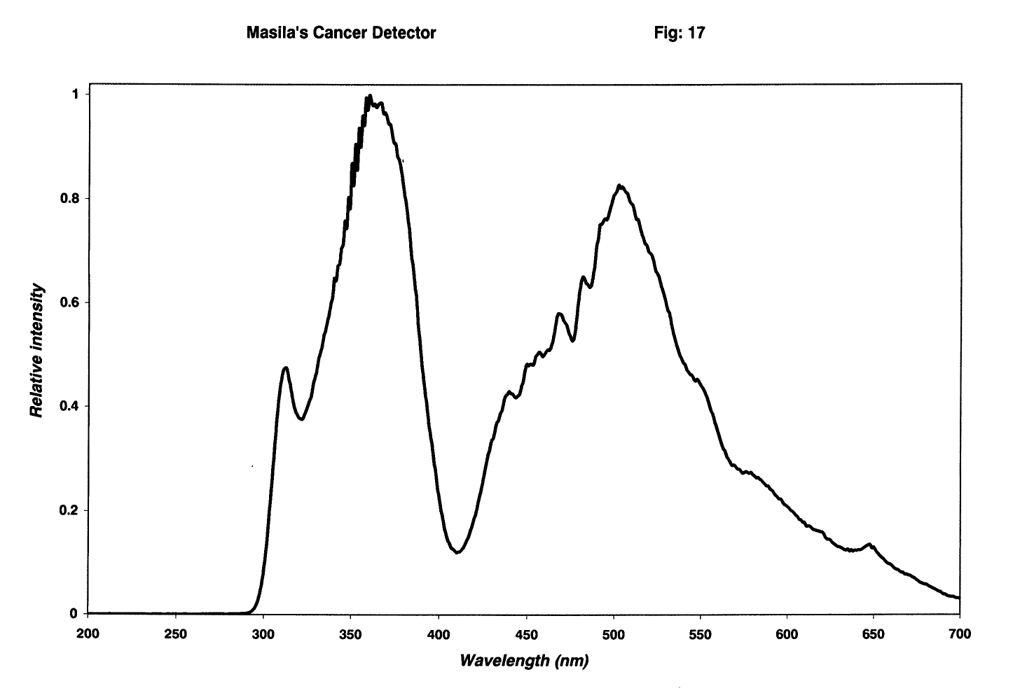

There are well-defined bands around 311 nm, 365 nm, 450 nm, 505 mn, 550 nm, and 620 nm. As plasma contains a host of free and enzyme bound flurophores (biomoulecules) we can only tentatively assign the bands to the fluorophores: Out of these, 311 nm is the sharp Raman Band of back ground plasma medium. 365 nm is most likely due to tryptophane; 450 nm due to NaD(P)H; 505 nm due to riboflavin and 555 nm due to bilirubin, 585 nm and 625 nm due to porphyrins. Comparing the healthy and diseased spectra one can see that these bio molecules are out of proportion in diseased blood. (See FIG. 17 for healthy 18 for diseased)

For example, the ratio of band at 311 nm (due to Raman spectra of water) and at 365 nm (due to tryptophane) is 0.7 for healthy and 1.8 for the advanced stage of cancer. (So the contrast parameter is 2.6); this ratio is 1.05 for early cancer and 0.83 for high risk or hyperplasia. Another important ratio is the concentration between tryptophane and porphyrin. This ratio (I₃₆₅/I₅₈₅) is 2.3 for healthy, 3.5 for high risk cases; 4.5 for early cancer and is 8.7 for advanced cases. Other similar fluorescence ratios are given in Table III shown below

TABLE III
SYNCHRONOUS SPECTRA OF BLOOD PLASMA

| FL. Int. Ratio | H | HR | E | A | C |
|---|---|---|---|---|---|
| R11 = 311/365 | 0.7 | 0.83 | 1.05 | 1.8 | 2.6 |
| R12 = 365/505 | 1 | 1.3 | 1.6 | 2.35 | 2.35 |
| R13 = 365/550 | 1.7 | 2.5 | 3.4 | 5.5 | 3.2 |
| R14 = 365/585 | 2.3 | 3.5 | 4.5 | 8.7 | 4 |
| R15 = 450/500 | 0.45 | 0.7 | 0.9 | 1.1 | 2.4 |
| R16 = 450/550 | 0.9 | 1.4 | 1.8 | 2.2 | 2.6 |

H—Healthy
HR—High Risk
E—Early stages of cancer
A—Advanced cases
C—Contrast Parameter

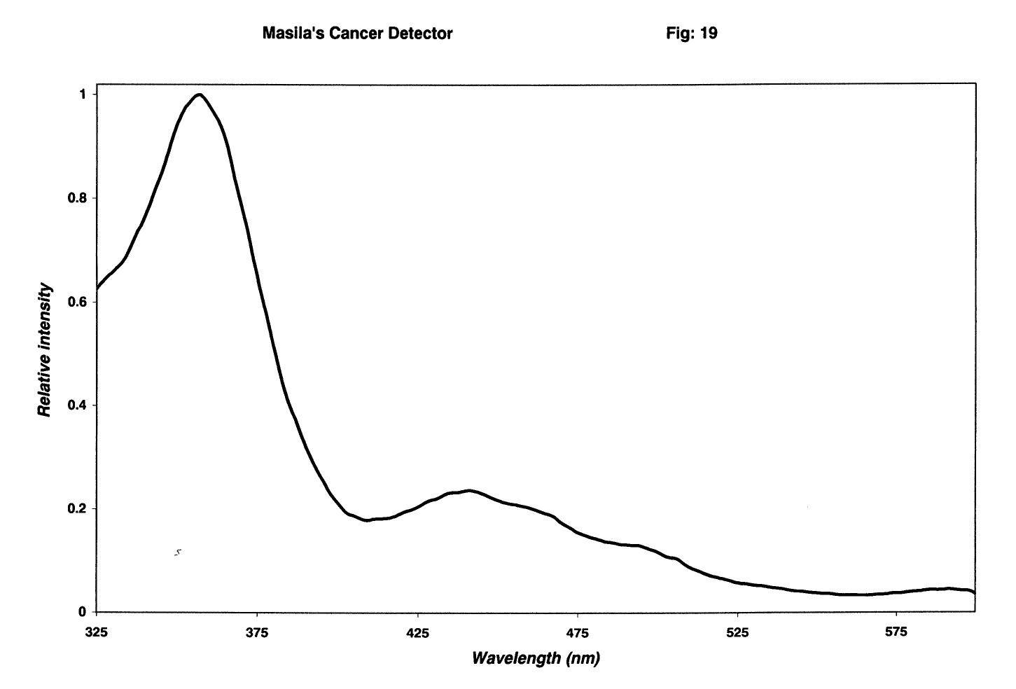

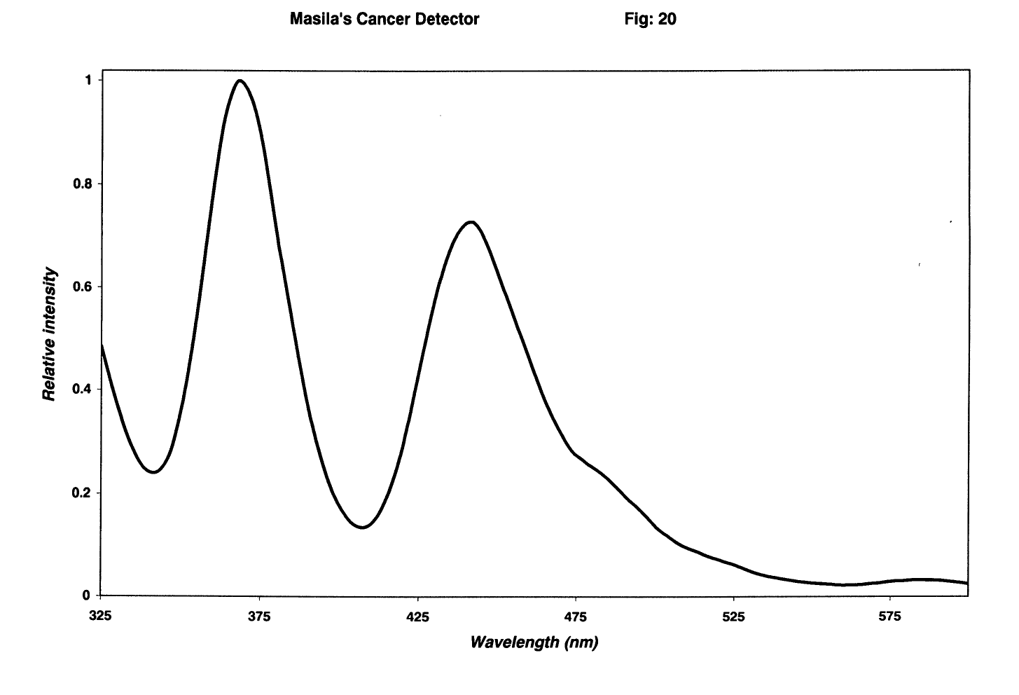

Next the instrument is set for synchronous spectra with the offset between two grating as 70 nm. Run the spectra as we did above. Here we get two bands of fluorescence, one at 355 nm and another at 450 nm and third one at 500 nm. Intensity ratio (R₁₇)=(I₄₅₀/I₃₅₅). This is about 0.4 for healthy, 0.6 for early cancer and greater than 1 for advanced cancer. (See FIGS. 19 and 20 for healthy and diseased) Here 355 nm is excitation spectrum of NAD(P)H and 450 mn is for flavins and bilirubin.

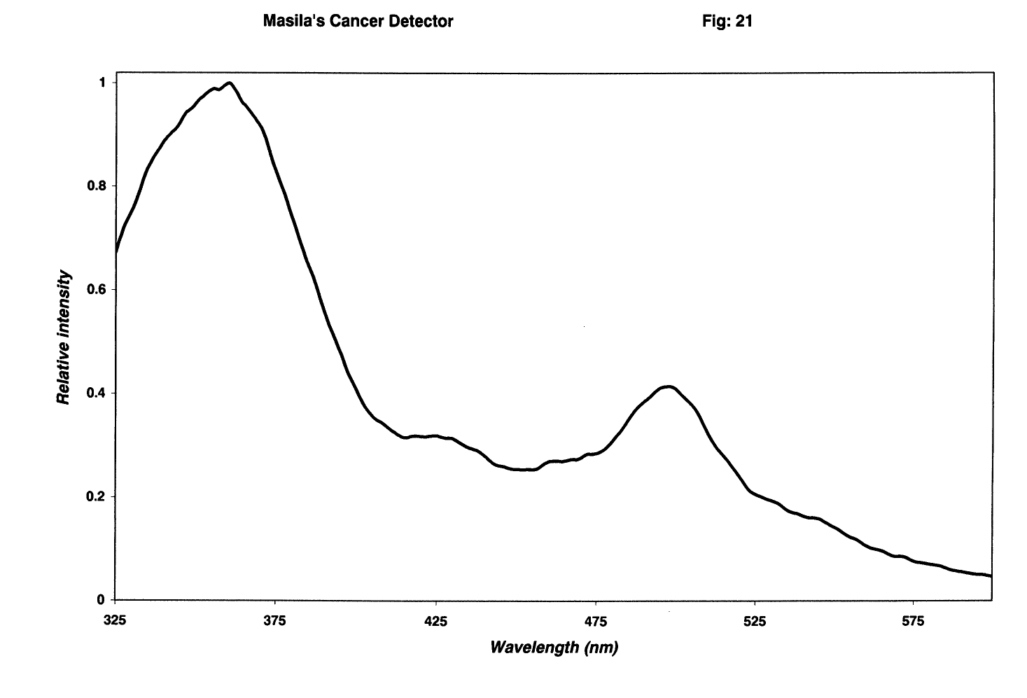

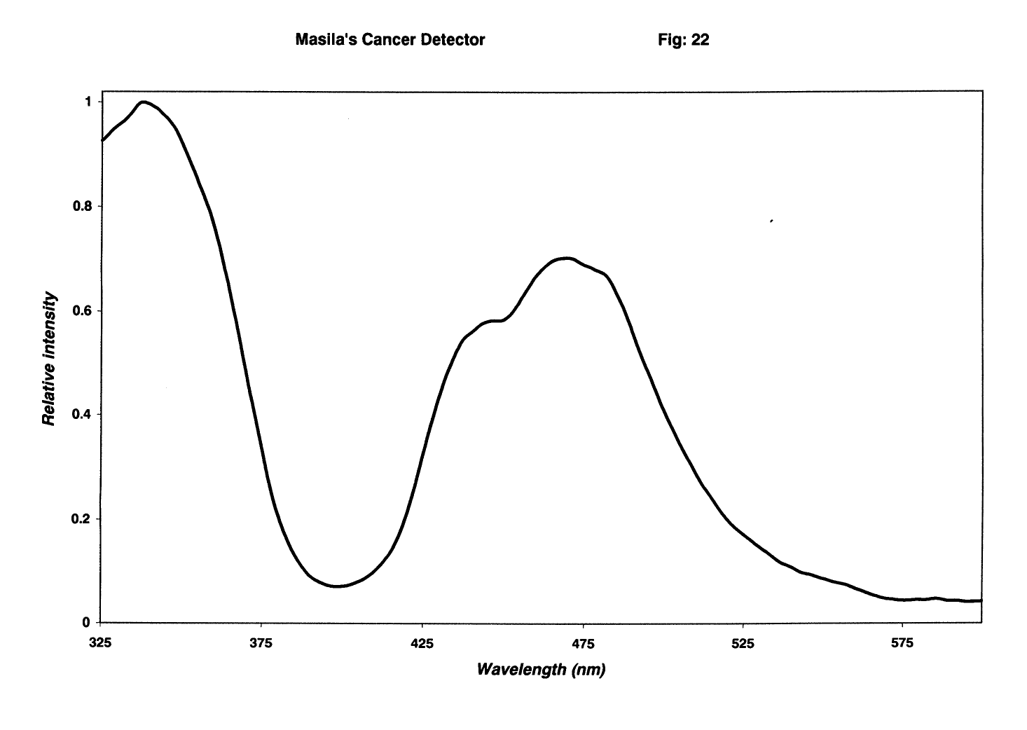

Now set the offset between two gratings as 30 nm. We get two bands one at 355 nm another 480 nm. See FIG. 21 for healthy and FIG. 22 for diseased.

$$( {R}_{ 18} ) = ( {I}_{ 480} / {I}_{ 355} ) \\ < 0.4 for healthy \\ > 0.4 for diseased .$$

Here again the elevation of flavins and Bilirubin are confirmed for diseased plasma.
Synchronous Spectra of Urine:

2 ml of fresh urine is dropped in the cuvette and run synchronous spectrums are run from 325 to 700 nm with an offset of 70 nm.

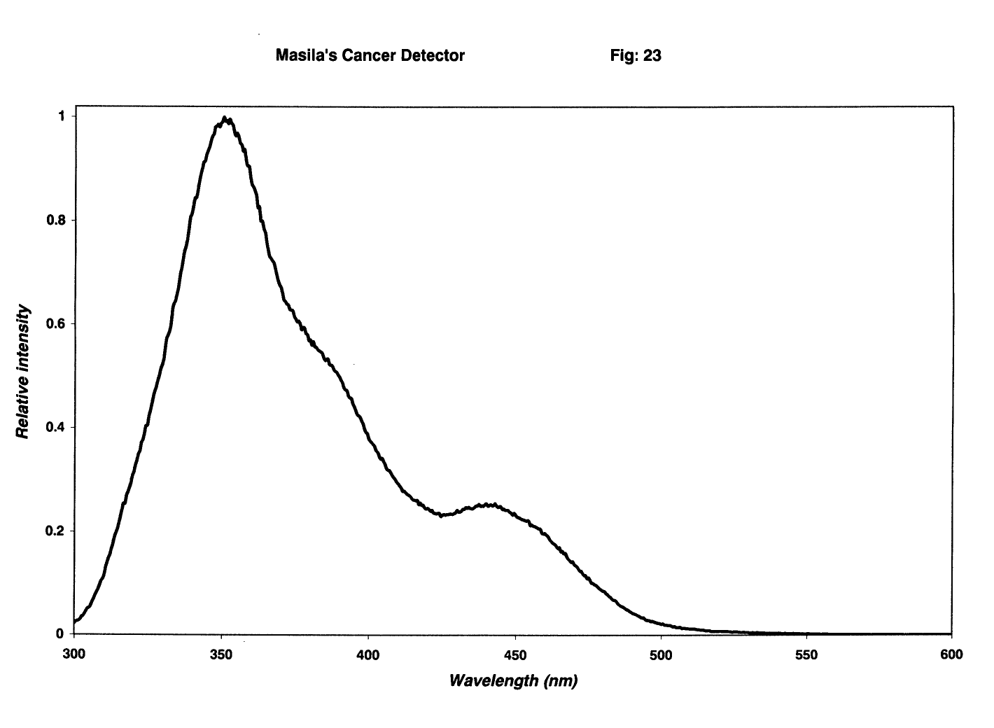

The intensities at 355 nm and 450 nm ( corresponding to NAD(P)H and bilirubin) are picked out. (See FIG. 23 for healthy and 24 for diseased)

We denote the ratios

R₁₉ = I₄₅₀/I₃₅₅

| if | R₁₉ < 1 | Healthy |
|---|---|---|
| | >1 <2 | Early Cancer |
| | >2 | Advanced Cancer |

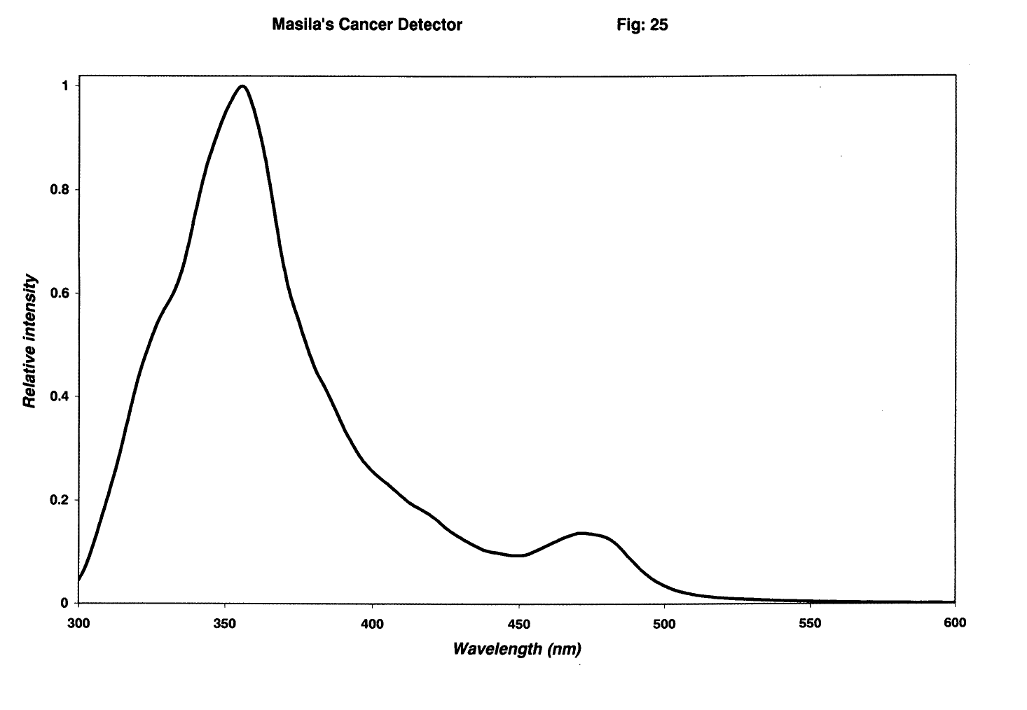

Synchronous spectrum is scanned for urine from 300-700 nm and again with an off set 70 nm in order to obtain the spectra. (See FIG. 25 for healthy and 26 for diseased.)

Define R₂₀ as the intensity ratios at I₄₈₀/I₃₅₅. (again due to bilirubin and NAD(P)H)

| | | |
|---|---|---|
| if | R₂₀ < 1.5 | Healthy |
| | 1.5 > R₂₀ < 4 | Early Cancer |
| | R₂₀ > 4 | Advanced Cancer |

We have done a study to diagnose cancer from urine alone (without any analysis of blood). Out of 178 samples of urine, 50 were from healthy volunteers of age 30-55 and 128 from diseased patients (mostly cancer of cervix or breast). Our optical diagnosis is more than 80% reliable as shown below in Table IV.

Note: In body fluids (blood plasma and urine) of cancer patients, flavins and bilirubins are higher concentration than for healthy. There is excellent one to correspondence between the findings of blood and urine.

TABLE IV
Urine Analysis

| Subjects | Number | Correct Optical Diagnosis | False+ | False− |
|---|---|---|---|---|
| Healthy | 50 | 45 | 5 | |
| Pre-malignant | 15 | 12 | | 3 |
| Cancer | 113 | 102 | | 11 |
| TOTAL | 178 | 159 | 5 | 14 |

Laser Induced Fluorescence of Urine

As mentioned earlier the source of light may be a coherent light like laser or incoherent light like a lamp. In order to confirm the results obtained by lamp excitation, as given in the preceding sections, the fluorescence emission tests are repeated with Titanium Sapphire Laser as the excitation source. The Ti-sapphire is readily available in the market and is used as such. It is pumped by a pulsed Nd YAG laser at 532 nm and this frequency doubled Ti-sapphire laser is tunable from 350 nm to 420 nm. The laser is tuned to 405 nm and the laser pulse of 5 milli joule energy and 10 ns pulse width fell on the sample kept in quartz cuvette. This is the only change instead of incoherent light with a band pass filter at 405 nm. The Laser Induced Fluorescence is collected at right angles to the incident laser and analyzed using a grating and diode array.

The test was done with the following samples:

1) PLASMA, EXTRACT of Formed Elements.

2) Urine and Extracts of Urine.

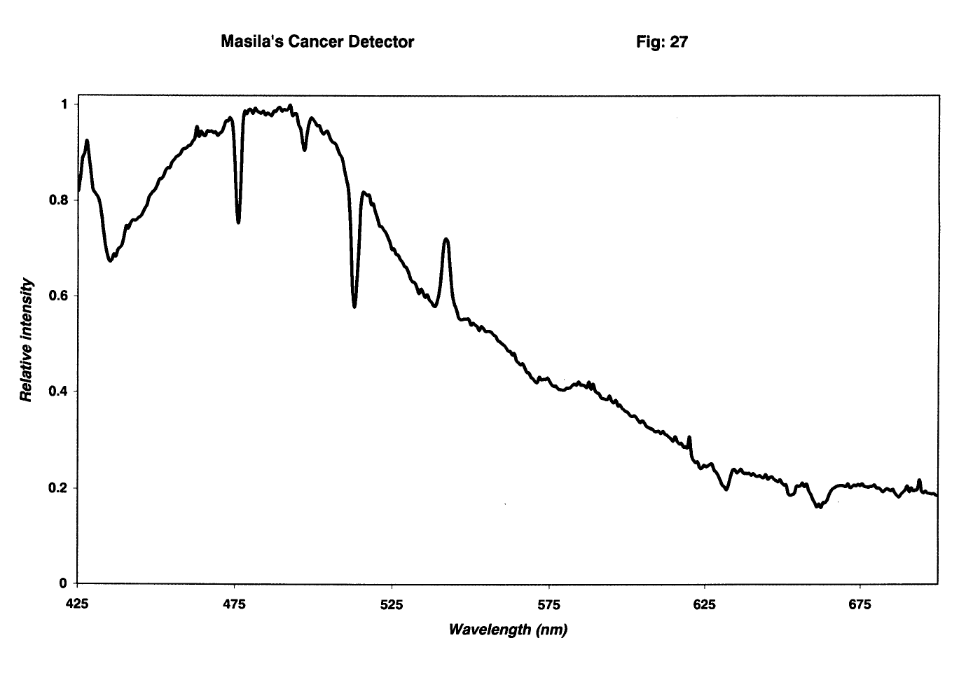

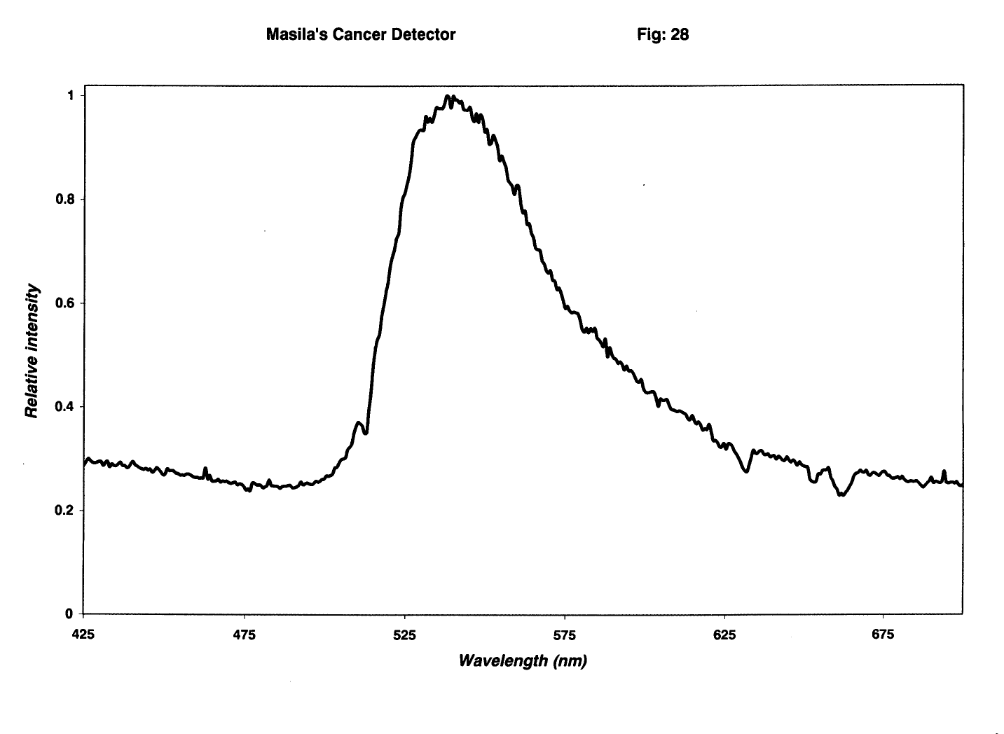

FIG. 27 shows the Laser Induced Fluorescence (LIF) of urine of healthy subject and FIG. 28 of Cancer diseased patient.

Here also I₅₅₀/I₄₇₀ is about 0.4 for healthy and is 1 for the diseased.

This is similar to the results of lamp excitation test.

In a similar fashion all other samples show the same trend. Other figures are NOT shown to avoid repetition. LIF spectra need more expensive instrumentation without any additional advantage in the quality of data.

Statistical Analysis

We did our statistical analysis based on the ratio's R1 to R20.

Hypothesis testing for the range of ratios:
Extract of Blood: The extract of blood was analyzed for 424 patients with different types of cancers (Table II). Consider ratio (R1), for those patients that R1 predicted correct result, the mean and standard deviation was calculated and we established the range for R1. The null hypothesis for testing the range was “The range selected was smaller or larger for predicting the correct result”. The level of significance (p) chosen was 0.025 (α=0.025 and β=0.025) and at that level we found that the ‘t’ value for 423 degrees of freedom was smaller than the table value of both α and β and hence we reject the null hypothesis and claim that the range predicted was correct.
Similarly we did the ‘t’ test for all the ratios and found the exact ranges of the ratio's for predicting the correct result. In some cases the range selected was smaller or larger and for those we increased or decreased the range and finally the ranges which we have listed in tables are those that confine to the condition that they are significant at α=0.025 and β=0.025.

Ratios that precisely determine the correct result (Multivariate analysis and Turkey Test):

We have 20 ratios and we need to determine by what percent each one of the ratios contribute to the final result if we were to use all the ratios to precisely obtain the result at p=0.05.

We consider each of the ratios as conditions (k1,k2, . . . ) hence we have 20 conditions. We map numerically the result Healthy, High Risk, Early and Advanced as below

| | |
|---|---|
| Healthy (H) | 0.5 |
| High Risk (HR) | 1 |
| Early (E) | 1.5 |
| Advanced (A) | 2 |

Observed result or the Actual result (OB)

We define X=abs (OB−R(k)) as the absolute difference in the prediction based on ratio R(k) and that of the observed result. For example if for a patient P1 ratio R1 predicts Healthy (0.5) and the observed result is actually Advanced (2) then
X=abs (OB−R(1))=1.5

We do this for all conditions and for all patients.

From ANOVA (Analysis of Variance ) we find that the means of all the conditions are significantly different at p=0.05.

We further did HSD (Honestly significant difference between means)

In ratios R1 to R20 we observed that R17 and R19 are not significant at p=0.05, similarly R20 and R16 are not significant at p=0.05. Excepting these all other ratios are significantly different.

Since the lowest value of X would mean that it is closest to the actual value the, mean that showed lowest X predicted the actual result most accurately Hence we assigned prediction values to each of the ratios that were found to give significantly different means.

So pre1 corresponds to prediction parameter R1, pre2 to R2 and so on.
pre1+pre2 . . . prek≡1
The final result (FR)=pre1*R1+pre2*R2+ . . . prek*Rk.

A χ² test was done between FR and OB. The null hypothesis was that there is a significant difference between the observed (OB) and the estimated result (FR) in predicting the category which the patient belongs (H, HR, E, A).

We found that FR and OB predicted almost the same result at significance level p=0.05.

Proprietary Software for Masila's Cancer Detector

Prototype of Masila's Software

The Masila's software is a user friendly software developed using MS VBA and MS Excel 2000. Once the spectral data is collected from the spectrometer the data is imported into MS Excel and when we run the macro it automatically calculates all the ratio's and does the statistical analysis as explained above and produces the final result. A future extension of the software would be to incorporate the driver programs so that Masila's cancer detector could be used as a turn key system for both data acquisition and data analysis. The password to run the macro is “elanmasila.”

Advantages of Masila's Cancer Detector

Useful for mass screening of cancer similar to diabetics mellitus test.

Useful at primary and secondary level of diagnostic test for cancer.

Useful to monitor cancer regression (or recurrence) after treatment.

Non-invasive and non-painful method to diagnose cancer.

No pre-requirement or special medication required for patients before diagnostic test.

A generic optical test to diagnose any type of cancer.

The diagnosis and result would take less than an hour.

A prototype of statistical analysis model for turnkey analysis and report is incorporated.

Instrumentation requires low capital investment and low maintenance with high throughput.

Operation of the instrument by technicians is simple.

Highly potential for marketing it in every clinic and hospital.

The instrumentation developed is compact and occupies approximately 3 ft×4 ft

In case of emergency, or use in remote village, 12V car battery is enough as power source.

It is extremely simple to setup, align and train technicians.

We claim:

1. An apparatus for optical analysis of body fluids for cancer detection comprising:
an optical source (1) for generating optical rays,
an excitation wavelength determining means (2) which receives the optical rays from said optical source (1) and transmits the optical rays at a predetermined wavelength,
a cuvette (4) for holding body fluids and for receiving the optical rays from the excitation wavelength determining means (2),
a grating (2 and 5) for receiving the optical rays from the cuvette (4) which are at right angles to the optical rays incident on the cuvette (4) and transmitting the optical rays with a predetermined wavelength,
a slit (S,S2) being provided between the said grating (25) and an optical conversion means (5) for directing the optical rays received at a particular wavelength from the grating (2,5) to the optical conversion means (6), said optical conversion means (6) being provided for converting the optical rays received from the said grating (2,5) to electrical signals, a computer (7) for receiving and processing the said electrical signals.

2. The apparatus as claimed in claim 1, wherein the said optical conversion means (6) is a photo detector or photo multiplier

3. The apparatus according to claim 1, wherein the said excitation wavelength determining means (2) is an interference filter.

4. The apparatus according to claim 1, wherein the said excitation wavelength determining means (F) is a notch filter.

5. The apparatus according to claim 1, wherein the said excitation wavelength determining means is a grating (2).

6. The apparatus according to claim 1, wherein a first focusing means is provided between the said excitation wavelength determining means and the said cuvette for focusing the optical rays received from the said excitation wavelength determining means to the said cuvette (4) and a second focusing means (L2) is provided between the said cuvette (4) and the said grating (G) for focusing the optical rays transmitted at right angles to the optical rays incident on the said cuvette (2).

7. The apparatus according to claim 1 wherein a first focusing means (L1) is provided between the said optical source (1) and the said grating (G1) for focusing the optical rays from the said optical source (1) to the grating (G1), and a second focusing means (L2) is provided between the said cuvette (2) and the said grating (G2) for focusing the optical rays transmitted at right angles to the optical rays incident on the said cuvette (2).

8. The apparatus according to claim 1 wherein a slit (S1) is provided between a mirror (M) and said cuvette (2) for directing the optical rays to the cuvette (2)

9. The apparatus according to claim 1 where the excitation source is a Ti Sapphire laser.

10. The technique and process of preparing the blood and urine samples and their extracts employing specific chemicals to elucidate cancer specific molecules such as Porphyrin, Billurubin, Riboflavin, Tryptophane, NaDPH, billiverdin.

11. The technique and process of ratio fluorometry to identify the spectral signature of cancer specific molecules in blood and urine such as Porphyrin, Billurubin, Riboflavin, Tryptophane, NaDPH, billiverdin.

12. The technique and process of diagnosing pre-malignant, early and advanced stages of cancer based on spectral signatures of molecules mentioned in claim 11 from urine and blood.

13. The technique and process of diagnosing cancer based on the concentrations of cancer specific molecules mentioned in claim 11.

14. The statistical analysis for the claim in 12.

15. The proprietary software that interfaces with the instrument mentioned in claim 1 and performs the statistical analysis mentioned in claim 12. This software is user friendly and produces a final report of the analysis.
